(19) United States
(12) Patent Application Publication
(10) Pub. No.: US 2006/0249603 A1
(43) Pub. Date: Nov. 9, 2006

(54) Adjustable drop sprinkler and installation tool

(76) Inventor: Robert L. Fletcher, Rohnert Park, CA (US)

Correspondence Address: EDWARD S. SHERMAN, ESQ., 3554 ROUND BARN BLVD., SUITE 303, SANTA ROSA, CA, 95403, US

(21) Appl. No.: 11/123,270

(22) Filed: May 5, 2005

(51) Int. Cl. B05B 1/00; A62C 37/08; A62C 2/00

(52) U.S. Cl. 239/600; 169/37; 169/43

(57) ABSTRACT

A component and tool improves the installation and adjustment of the adjustable drop sprinkler heads used in fire protection. The component is a flange that is installed above the sheet rock to engage the polygonal nut that surrounds and turns the extension tube. The flange is preferably shaped as a circular disk that extends up to less than the diameter of the installation hole cut in the sheet rock. The circular disk has a plurality of mating holes spaced about the periphery such that a pipe-shaped tool with mating features on its ends can grasp and optionally rotate the extension tube from below the ceiling. Simultaneously, a sprinkler head can be inserted, adjusted or removed from the end of the extension tube using a conventional tool inserted into the other end of the pipe-shaped tool.

### CROSS REFERENCE TO RELATED APPLICATIONS

None

### BACKGROUND OF INVENTION

The present invention relates to fire protection sprinkler heads, and more specifically tools and methods for their installation and adjustment.

Overhead sprinkler systems are routinely deployed in commercial buildings for fire protection. Water is retained in a system of pressurize pipe. The pipe and associated spray heads are position above the floor, which is generally concealed above the ceiling or in all areas of the building. The sprinkler heads only upon when the heat reaches the level of fire. Thus, the water will extinguish a fire before it has a chance to spread in the building. Such systems are becoming more prominent in residential homes, in particular when they reach a critical size.

FIG. 1 illustrates the general environment and purpose of the invention, showing how a water pipe 10 mounted within the ceiling 5 that is above sheetrock 12 or other ceiling material turns in a 90 degree bent section 8 to feed a heat sensitive sprinkler head 15.

Sprinkler head 15 is conventional, having a water outlet 16 that opens upon exposure to the heat or a fire, a water diverting spray disc 17 below the water outlet 16 a threaded end 18 for attachment to the extension tube 20 and a polygonal wrench receiving flange 19. As it is desirable to be able to adjust the height of the sprinkler head relative to the sheetrock, an extension tube 20 is connected to the down faced end 8a of the 90 degree bent section 8 of the water pipe 10. The 90-degree bent section 8 and the extension tube 20 has mating threads, which are not shown in the following diagrams. The extension tube length is adjusted by rotating polygonal wrench receiving flange 22 disposes on the exterior of the extension tube, approximately mid-way between the ends 20a and 20b thereof. The installer inserts a wrench through the hole 30 in the sheet rock to make this adjustment. Likewise, a sprinkler head is attached by mating threads into the other side of the extension tube.

If the installer wishes to remove or replace the sprinkler head, it is highly desirable to prevent the extension tube from rotating so that the sprinkler head can be removed from it. However, after the sprinkler head is installed there is no clearance between the sheetrock and the head to insert a hand, let alone to grasp wrench-receiving flange with a wrench. Further, after the sprinkler system has been activated, that is pipe is filled with pressurized water, some water will remain captured above the sprinkler head even if the water valve is shut and the pipe is drained downstream. As it is difficult to not only remove the sprinkler head after installation, at least without also unthreading the extension tube, doing so invariably result in the uncontrolled release of the trapped water, causing damage to the sheetrock.

Accordingly, an object of the present invention is provide a device, tools and methods that facilitate the rapid installation and adjustment of fire protection sprinkler heads that descend from a ceiling into a room.

It is a further objective of the invention to provide a facile means for re-adjustment of the sprinkler head vertical position after a ceiling is installed

Still, yet another objective of the invention to provide a means to avoid physical damage to ceiling material, such as sheet rock if re-adjustment, retrofitting or repair is required after ceiling installation.

A further objective of the invention is to avoid entering the attic space above the ceiling if re-adjustment, retrofitting or repair is required after ceiling installation.

An additional objective of the invention is to avoid water damage to the room or ceiling materials during replacement or service after the fire protection system has been filled and pressurized with water.

### SUMMARY OF INVENTION

In the present invention, the first object is achieved by provide a surround flange fixture that can be inserted over an installed sprinkler head to engage the wrench receiving flange disposed at the middle thereof.

A second aspect of the invention is characterized in that a circular installation tool is provided to insert around the sprinkler head and engage the surrounding flange so that it can optionally be rotated, or held in place as the sprinkler head is remove with a socket reach extension inserted through the circular tool. The circular installation tool forms a substantially water tight connection with the surrounding flange such that residual water above the sprinkler head is diverted through it to a container, well clear of the ceiling material.

At third aspect of the invention is to provide an extension tube having an integral surrounding flange such that it can be adjusted with the aforementioned circular tool.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-sectional elevation showing the exploded components of an overhead fire protection sprinkler head.

FIG. 2 is a cross-sectional elevation showing the exploded components of an overhead fire protection sprinkler head, including the inventive surrounding flange.

FIG. 3A is a cross-sectional elevation of an alternative embodiment of a surrounding flange.

FIG. 3B is a top plan view of the surrounding flange of FIG. 3A.

FIG. 3D is a cross-sectional elevation of a tool use in conjunction with the surrounding flange of FIGS. 2 and 3.

FIG. 4A is a cross-sectional elevation of an alternative embodiment of a surrounding flange.

FIG. 4B is a top plan view of the tool of FIG. 3C

FIG. 4C is a cross-sectional elevation of a tool use in conjunction with the surrounding flange of FIG. 2-4, taken at reference line C-C′.

FIG. 4D is an exterior elevation of the tool of FIG. 4C, as viewed from the direction shown in FIG. 4B at reference line D-D′

FIG. 5 is an exterior elevation of an alternative embodiment of the tool.

FIG. 6A is a cross-sectional elevation of an installed alternative embodiment of the invention as an extension tube adjustable via the operation of the tool of FIGS. 3D, 4C, 4D and 5.

FIG. 6B is a plan view of the embodiment of FIG. 6

FIG. 6B is a cross-sectional elevation of the embodiment of FIG. 6A.

### DETAILED DESCRIPTION

Referring to FIGS. 2 through 4, wherein like reference numerals refer to like components in the various views, there is illustrated therein a new and improved flange, generally denominated 200 herein.

In accordance with the present invention, the aforementioned difficulties in removing, adjusting or replacing sprinkler heads in a ceiling or attic space are alleviated as shown in FIG. 2, which illustrates how the inventive surrounding flange is installed over the installed sprinkler head, and deployed to either seize or adjust the length of the extension tube 20. Surrounding flange 200 is preferably a circular sheet 205 of material that is planar (flat) on at least one surface. It has a central bore 210 for mating to polygonal flange of extension tube. Further, a series of peripherally disposed mating feature 220 are provided for receiving an installation tool that can also be inserted around the attached sprinkler head.

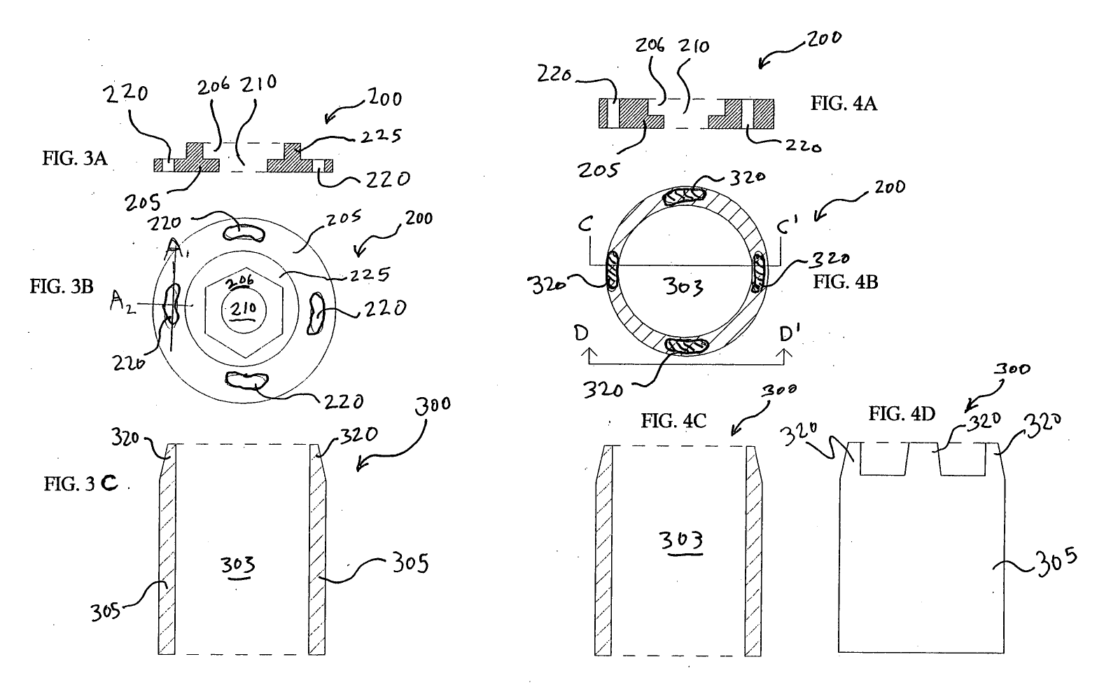

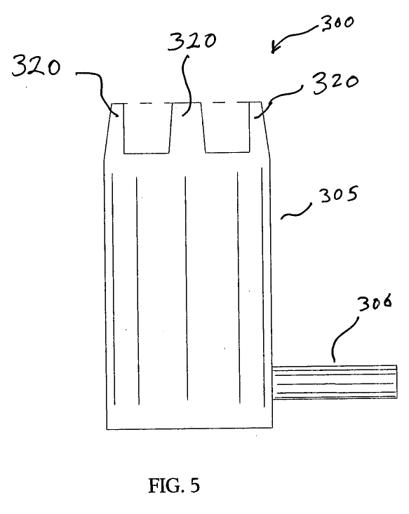

FIGS. 3A and 3B illustrates an alternative embodiment of surrounding flange 200 in further detail. Surrounding flanges 200 includes a co-axially disposed polygonal pocket 206 for receiving the corresponding flange on the extension tube. In this embodiment pocket 206 is formed with the shoulder 225 that extends upward concentric with circular sheet 205. In the alternative embodiment of FIGS. 4A and 4B, surrounding flange 200 does not have a shoulder, as the flange has a constant thickness, with pocket 206 being formed in the upper section of central bore 210.

Preferably, surrounding flange 200 is round and has an outer diameter of at least about 2 inches and preferably 3 inches. In the more preferred embodiment, surrounding flange 200 also extends downward to rest on the shoulder of the sprinkler head. Alternatively, the surrounding flange 200 can be held in place by tape, adhesives, caulking and like materials for semi-permanent attachment. Providing the pocket 206 in shoulder 225 allows the surrounding flange 200 thinner at edges than at the center adjacent the polygonal pocket 206. Mating features at the periphery of the flange are preferably a series of holes 220. More preferably, holes 220 equally spaced about the periphery of the flange 200. Most preferably, holes 220 are non-circular and have a principle axis, A₁, disposed tangentially with respect the edge of the flange, and the secondary axis A₂, disposed orthogonal to A₁ and aligned in the radial direction with respect to the flange. Also shown in this embodiment, preferably the holes 220 are kidney shaped to match the profile of a tool formed by cutting notches out of a circular pipe, described in further detail below with respect to FIGS. 4 and 5 below.

The use of holes 220 as mating features is merely an exemplary embodiment, as alternative may be nub or protrusion that extends downward from the flat face to engage in mating holes in a tool that is otherwise comparable to that described in further detail with respect to FIGS. 4 and 5 below.

Referring to FIGS. 3C through 5, wherein like reference numerals refer to like components in the various views, there is illustrated therein a new circular installation tool adopted to act upon surrounding flange 200, generally denominated 300 herein.

Circular tool 300 has a barrel section 305 and a plurality of prongs 320. Prongs 320 are designed to engage holes 220 of surrounding flange 200. Thus, installation tool 300 is readily fabricated from a pipe with at least a 2½″ ID wherein notching out a section of the end wall in a symmetric x-pattern produces a series of circumferentially disposed mating features or prongs 320 for engaging opposing mating features of the surrounding flange 200. Thus, installation tool 300, being formed from a section of pipe is adapted to form a water barrier when coupled to the mating features, such that water trapped above the sprinkler head 15 will directed down through its center.

Preferably, as shown in FIGS. 4C and 4D, the prongs 320 that constitute the mating features of installation tool 300 taper inward toward the center of the tube as they extend upward from the tube. The tapered shape makes it easier for the installer to align and install the tool into the flange 200 by feel alone, as they are working from below the usually ceiled attic space.

In an alternative embodiment shown in FIG. 5, installation tool 300 has a laterally extending handle 306. The handle enables the installer to apply additional advantage to hold the extension tube when the sprinkler head 15 is removed or merely adjusted in height relative to the ceiling as the extension tube is rotated upward or downward in the threads that engage bent section 8.

Preferably, installation tool 300 has a length of at least about 5 in., but is of a sufficiently short height to allow an extension socket to be used to remove the sprinkler head.

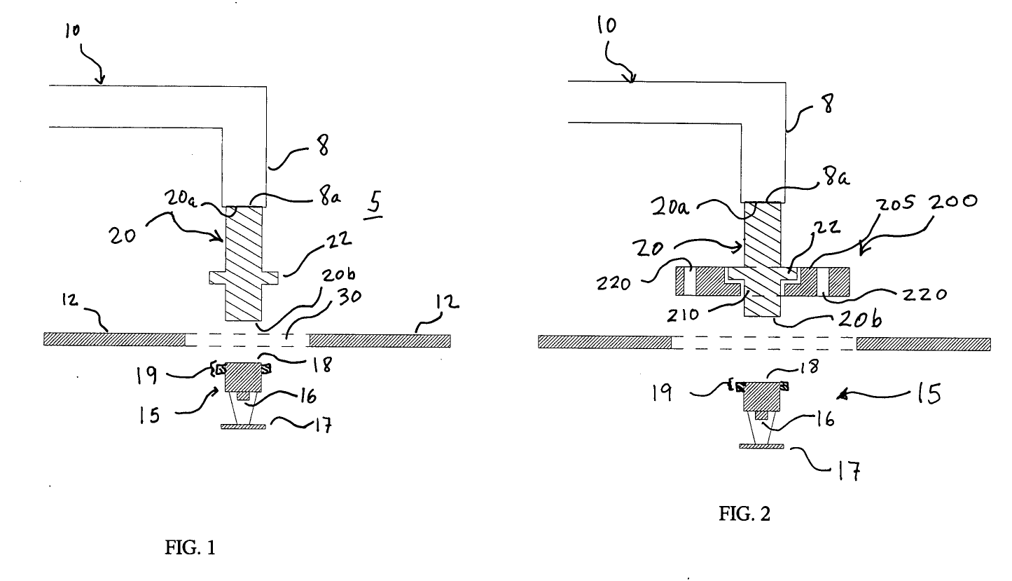

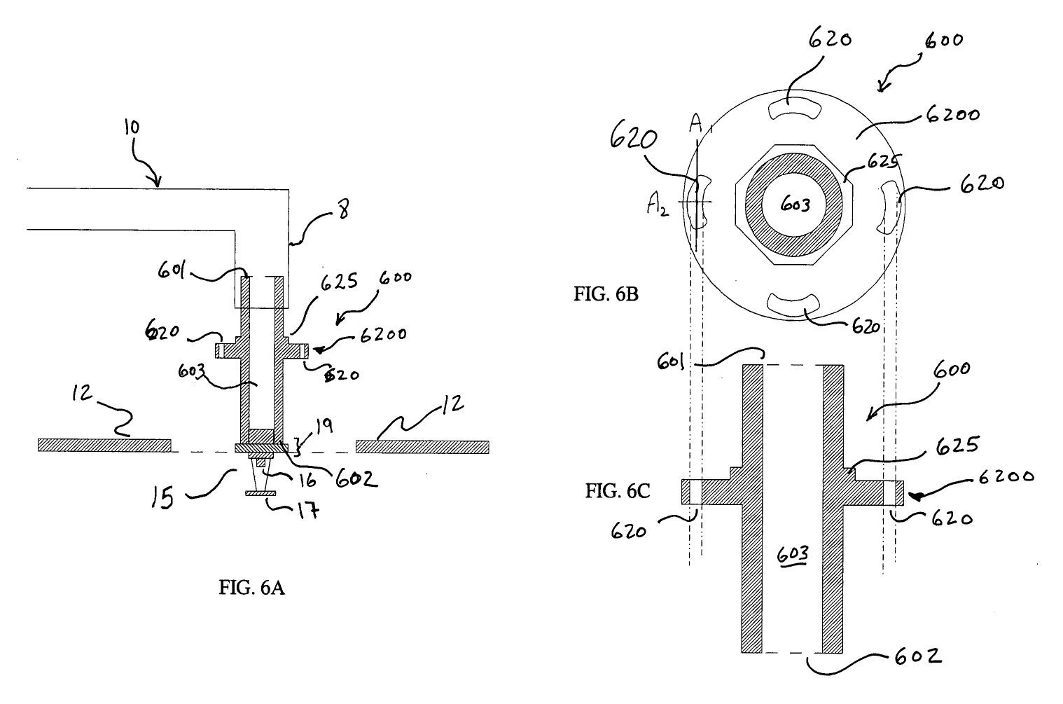

Referring to FIGS. 1, 2 and 6, wherein like reference numerals refer to like components in the various views, there is illustrated therein a new and improved extension tube, generally denominated 600 herein.

In this embodiment of the invention, extension tube 600 is provided with a surrounding flange 6200 as an integrated assembly. Comparable to the extension tubes of FIGS. 1 and 2, extension tube 600 is threaded on both ends 602 and 601 leaving a central bore 603 for water to flow to the attached sprinkler head, 15. The surrounding flange 6200 is disposed intermediate between ends 601 and 602 and preferably has a polygonal wrench receiving shoulder 625. Mating features at the periphery of the flange 6200 are a series of holes 620. These mating features are equally spaced about the periphery of the flange 6200. As shown, it is preferable that holes 620 are non-circular and have a principle axis, A₁, disposed tangentially with respect the edge of the flange, and the secondary axis A₂, disposed orthogonal to A₁ and aligned in the radial direction with respect to the flange. Also shown in this embodiment, preferably the holes 620 are kidney shapes to match the profile of a tool formed by cutting notches out of a circular pipe, having the inward edge of the curvatures disposed toward the center of the flange.

It should be appreciated that aspects, features and constructions of subcomponents described with respect to one embodiment of the Extension tube 600 may be interchanged with equivalent features in other embodiments with departing from the intended scope of the invention, as may be within the spirit and scope of the invention as defined by the appended claims.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A surrounding flange comprising:
a) a circular plate that is substantially planar on a first surface, having a second surface on the opposing face,
b) a centrally disposed polygonal bore having lateral walls that extend orthogonally between the first and second surface of said circular plate,
c) two or more equally spaced mating features disposed at the periphery of said circular plate.

2. The surrounding flange of claim 1 further comprising four or more the mating features.

3. The surrounding flange of claim 2 wherein the mating features are a series of equally spaced holes.

4. The surrounding flange of claim 3 wherein the mating features have a kidney shape with the shorter concave side of the kidney shape facing the center of the flange and said circular plate is circular.

5. The surrounding flange of claim 1 wherein said centrally disposed polygonal bore is formed within a central shoulder of the surrounding flange such that surrounding flange is thinner at the edges adjacent the mating features than at the edge of said polygonal bore.

6. A tool and surrounding flange kit comprising:
a) a surrounding flange having;
i) a circular plate that is substantially planar on a first surface, having a second surface on the opposing face,
ii) a centrally disposed polygonal bore having lateral walls that extend orthogonally between the first and second surface of said circular plate,
iii) a first plurality of equally spaced mating features disposed at the periphery of said circular plate, and
b) a tool for engaging optionally rotating or preventing the rotation of said flange, the tool comprising;
i) a tube having a first open end and a second open end,
ii) a second plurality of equally spaced mating features that engage the first set of mating features of the surrounding flange being disposed at the periphery of the tube such that rotating said tube rotates said surrounding flange.

7. The kit of claim 6 wherein the surrounding flange is circular and comprises 4 or more comprising four or more equally spaced mating features.

8. The kit of claim 7 wherein the mating features are holes.

9. The kit of claim 8 wherein the holes have a kidney shape with the shorter concave side of the kidney shape facing the center of said flange.

10. The kit of claim 6 wherein the mating said tool to said surrounding flange results in a substantially water tight seal at the interface there between.

11. A sprinkler assembly:
a) an extension tube having a first threaded end and a second threaded end,
b) a surrounding flange disposed orthogonally with respect to the cylindrical axis of the extension tube as a circular disk having at least one substantially planar face disposed toward the first threaded end wherein a periphery of equally spaced mating features are disposed substantially about the periphery of the circular disk,
c) a sprinkler head having a threaded end that engages the first threaded end of said extension tube.

12. A sprinkler assembly according to claim 11 wherein the surrounding flange is integral to the sprinkler assembly.

13. A sprinkler assembly according to claim 11 wherein the surrounding flange is separate from the sprinkler assembly.

14. A process for installing a sprinkler assembly, the process comprising the steps of:
a) providing an extension tube threaded into and extending downward from a water pipe at the proximal end and having a threaded distal end with a polygonal flange disposed between the proximal and distal ends thereof,
b) providing a surrounding flange comprising:
i) a circular plate that is substantially planar on a first surface, having a second surface on the opposing face,
ii) a centrally disposed polygonal bore having lateral walls that extend orthogonally between the first and second surface of said circular plate, wherein the internal walls of the polygonal bore mate with the polygonal flange of the extension tube,
iii) a plurality of equally spaced mating features disposed at the periphery of said circular plate,
c) providing a spray nozzle having a threaded end,
d) inserting the surrounding flange around the polygonal flange of the extension tube,
e) threading the spray nozzle into the distal end of the extension tube.

15. The process of claim 14 further comprising the step of affixing the surrounding flange to the extension tube.

16. A tool for installing and adjusting a sprinkler assembly, the tool comprising:
a) a tube having a first open end and a second open end with an inner diameter of at least 2 about inches,
b) a plurality of equally spaced mating features disposed at the periphery of the tube,
c) a handle extending laterally perpendicular from the principle axis of the tube,
d) wherein the mating features at the periphery of the tube are provided to engage a set of mating features of a flange whereby turning the hand to rotate the tool rotates the engaged flange.

17. A tool for installing and adjusting a sprinkler assembly according to claim 16 wherein the mating features are prongs that extend outward from the peripheral side of said tube, being contiguous with the outer surface of said tube.

18. A tool for installing and adjusting a sprinkler assembly according to claim 16 wherein the mating features are prongs that extend outward from the peripheral side of said tube having their outside surface taping inward toward the center of said tube.

19. A tool for installing and adjusting a sprinkler assembly according to claim 16 further comprising a handle extending laterally from at least one side of said tube.

20. A tool for installing and adjusting a sprinkler assembly according to claim 16 having a length along the axis of said tube of at least about 5 inches.
